(19) United States
(12) Patent Application Publication
(10) Pub. No.: US 2007/0272726 A1
(43) Pub. Date: Nov. 29, 2007

(54) Method for jointing golf club head

(75) Inventors: Jiun-Kai Hsu, Kaohsiung County (TW); Ying-Sen Hsu, Kaohsiung City (TW)

Correspondence Address: BIRCH STEWART KOLASCH & BIRCH, PO BOX 747, FALLS CHURCH, VA, 22040-0747, US

(73) Assignee: Advanced International Multitech Co., Ltd.

(21) Appl. No.: 11/598,024

(22) Filed: Nov. 13, 2006

(30) Foreign Application Priority Data
May 29, 2006 (TW) 095119036

(51) Int. Cl. A47J 36/02

(52) U.S. Cl. 228/101

(57) ABSTRACT

A method for jointing a golf club head is provided, which uses a brazing joint process to perform the jointing operation. The method includes steps of providing a first component, providing a second component, coating a layer of active metal suitable for jointing with an active metal solder on the first component and the second component, and jointing the first component with the second component, such that the first component and the second component are jointed together. The method for jointing a golf club head effectively reduces the processing cost of introduced protective gas and metal solders, and prevents the high-temperature oxidation of the golf club head. In addition, the process can be performed in a continuous furnace, so as to effectively improve the overall production capacity and yield.

### CROSS-REFERENCE TO RELATED APPLICATIONS

This non-provisional application claims priority under 35 U.S.C. §119(a) on Patent Application No(s). 095119036 filed in Taiwan, R.O.C. on May 29, 2006, the entire contents of which are hereby incorporated by reference.

### BACKGROUND OF THE INVENTION

1. Field of Invention

The present invention relates to a method for jointing a golf club head, and more particularly, to a method for jointing a golf club head that reduces the production cost and increases the overall production capacity and yield.

2. Related Art

In a conventional golf club head structure, a striking plate is generally combined by means of embedding or together with various welding methods. However, the aforementioned combining methods have many disadvantages, for example, by the embedding process, the striking plate is easy to deform after a period of time, and the welding compatibility is poor if welding club head body and the striking plate that are made of different materials. Moreover, if a conventional welding technique that is operated at a temperature higher than the melting point of the work piece to be welded is used, the original processing precision before the jointing cannot be maintained, and it is difficult for the joint surface between the golf club head body and the striking plate to be processed into a flat and smooth surface. Furthermore, the structural properties of the body and the string plate are easily affected, causing the stress concentration and high deformation, thus, the structural processing precision before the jointing cannot be maintained. In addition, the joint surface of the golf club head body and the striking surface is not smooth, and it has to be processed and shaped during the subsequent process, so as to complete the golf club head.

To overcome the disadvantages of the aforementioned conventional combining structure of the striking plate and the golf club head, a technique of directly bonding and combining the striking plate with a high strength glue under a room temperature is developed in the conventional art. However, restricted by the upper limit of the bonding strength of the high-strength glue, the club head body and the striking plate that are combined together cannot provide enough combining strength to support the stresses of the strikes, although the combining process is accelerated through bonding the club head body with the striking plate.

Therefore, a brazing joint process is also used to joint the joint club head body with the striking plate in the conventional art. However, currently, when the brazing joint process is performed on a golf club head made of titanium material, as the work piece is easily oxidized at a high temperature, and the hard solder used in the process contains active elements such as titanium, the process must be performed in a vacuum furnace, or argon gas must be introduced into a gas furnace to protect the work piece from being oxidized. However, currently, a vacuum furnace and a gas furnace are used to perform the brazing joint process, which is aimed at protecting the work piece or hard solders from being oxidized. If the work piece or the hard solder is oxidized, they cannot react with each other to achieve the brazing jointing object. Moreover, as the vacuum furnace must be vacuumed to perform the jointing of titanium according to the conventional brazing joint process, the process is time-consuming, the production capacity is lowered, and the vacuuming process is difficult to control, and a slight air leakage causes all the work pieces in the vacuum furnace be oxidized, contaminated, and become useless. Moreover, as the argon gas must be introduced into the gas furnace to protect the work piece or hard solder from being oxidized, so as to perform the brazing joint process smoothly, thus, the cost is extremely high due to using the argon gas in the gas furnace for protection. In addition, both the vacuum furnace and the gas furnace are enclosed furnaces, so the production capacity is lower than that of the semi-opened continuous furnace. Furthermore, the titanium-containing active metal solder that requires vacuuming or argon gas for protection in the process is expensive, which also increases the cost.

Therefore, when the conventional golf club head made of titanium material is jointed through a brazing joint process, it is restricted by the disadvantages that the conventional brazing joint process easily causes the titanium to be oxidized, the production capacity is reduced, and the cost is much higher. Meanwhile, the conventional jointing technique has many defects in the jointing process, therefore, it has become a task for research and development in this field to redesign a method for jointing a golf club head that is capable of protecting the work piece from being oxidized, increasing the production capacity, and reducing the cost.

### SUMMARY OF THE INVENTION

In view of the above, the present invention provides a method for jointing a golf club head, which solves the problem that the expensive argon gas must be introduced to prevent the high-temperature oxidation when a golf club head made of titanium material is jointed through a conventional brazing joint process, and also overcomes the disadvantage that the overall production capacity and yield cannot be enhanced as the conventional art is limited to be implemented in a vacuum furnace or in a gas furnace with the argon gas.

To achieve the aforementioned object, the present invention provides a method for jointing a golf club head, which uses a brazing joint process to conduct the jointing operation. The method includes steps of providing a first component, providing a second component, coating a layer of active metal suitable for jointing with an active metal solder on the first component and the second component, and jointing the first component with the second component.

Firstly, a first component made of titanium material and having a joint surface is provided. Next, a second component made of metal material and having a joint surface is provided. Then, a layer of active metal is coated on the first component and the second component, which is suitable for jointing with an active metal solder. Finally, the first component is jointed with the second component. Thus, the first component and the second component are assembled, and the active metal solder is added for jointing the two components together. Then, the two components are placed in a continuous furnace or a gas furnace, and the nitrogen gas is introduced into the furnace. By introducing the nitrogen gas to the heated first and second components, the solder is melted on the joint surface between the first component and the second component, such that the first component and the second component are jointed together.

At least the following effects are achieved through implementing the method for jointing a golf club head of the present invention.

1. The present invention discloses a method for jointing a golf club head, which uses a brazing joint process to perform the jointing operation. Through the method for jointing a golf club head, the body and the striking plate can be jointed in a continuous furnace. Thus, the production capacity and the yield of the golf club head products are increased compared with the conventional art that uses the vacuum furnace or the gas furnace to joint the golf club head.

2. The present invention discloses a method for jointing a golf club head, which uses a brazing joint process to perform the jointing operation. Through the method for jointing a golf club head, only the nitrogen gas is required for protection during the subsequent brazing joint process of the golf club head so as to prevent the high-temperature oxidation, as the work piece is covered and protected by a layer of active metal. Thus, the cost is lower than the conventional art that uses argon gas as the protective gas, and titanium-free solders can be used as the solder for the brazing joint process of titanium, thus, the overall processing cost is reduced compared with the conventional art that the titanium-containing solder only can be used in the vacuum or argon gas protection atmosphere.

To further understand the object, structure, features, and functions of the present invention, the present invention is illustrated below in detail through the embodiments with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a flow chart of a method for jointing a golf club head according to a preferred embodiment of the present invention;

FIG. 2 is a schematic view of a first aspect of a golf club head jointed through the method for jointing a golf club head of the present invention;

FIG. 3 is a schematic view of a second aspect of the golf club head jointed through the method for jointing a golf club head of the present invention; and

FIG. 4 is a schematic view of a third aspect of the golf club head jointed through the method for jointing a golf club head of the present invention.

### DETAILED DESCRIPTION OF THE INVENTION

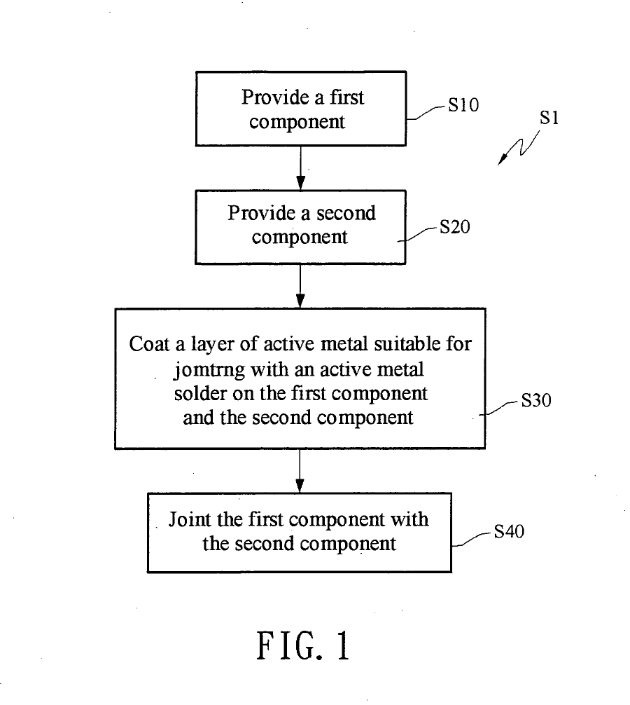

As shown in FIG. 1, the present invention discloses a method for jointing a golf club head, which uses a brazing joint process to perform the jointing operation. The method for jointing a golf club head S1 in one preferred embodiment includes providing a first component (Step S10), providing a second component (Step S20), coating a layer of active metal suitable for jointing with an active metal solder on the first component and the second component (Step S30), and jointing the first component with the second component (Step S40).

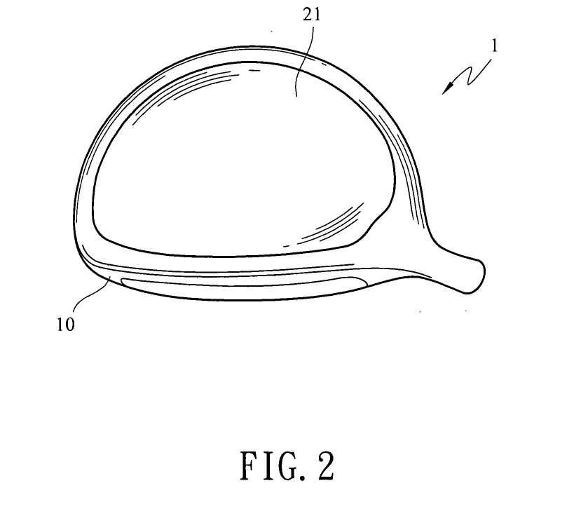

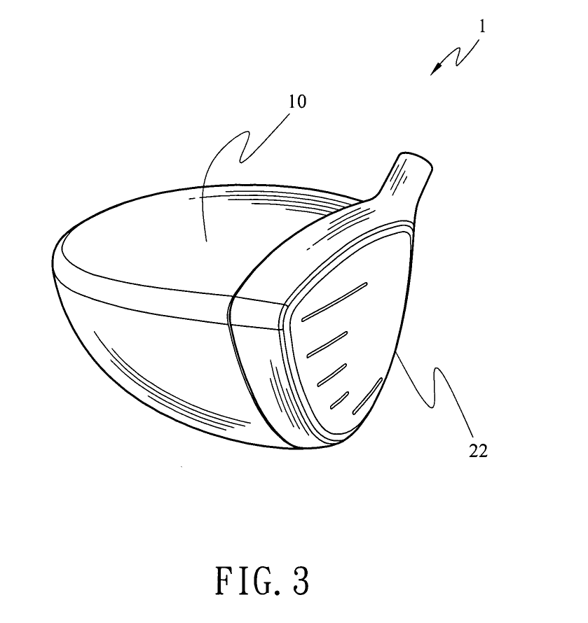

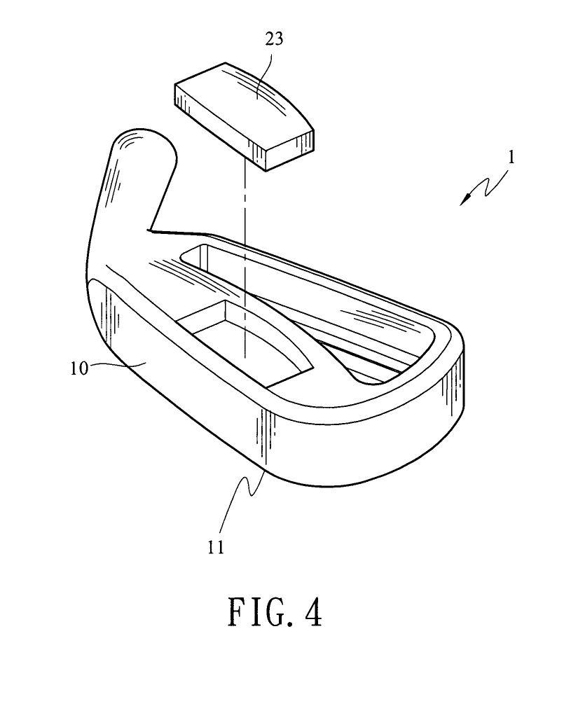

Referring to FIGS. 1 and 2, the present invention discloses a method for jointing a golf club head, which uses a brazing joint process to perform the jointing operation. According to one preferred embodiment of the method for jointing the golf club head S1, a first component 10 is provided first (Step S10), which is made of titanium material and has a joint surface; next, a second component is provided (Step S20), which is made of a metal material and has a joint surface. In this preferred embodiment, the first component 10 is a body, and the second component is a head cover 21. Certainly, the second component can also be a striking plate 22, which is particularly cup-shaped, as shown in FIG. 3. Alternatively, the second component can be a balance weight 23. The first component 10 does not include a striking surface, or a side surface of the first component 10 is formed into a striking surface 11, as shown in FIG. 4. Certainly, the first component 10 also can be a striking plate or a head cover, and the second component is the body; or the second component does not include a striking surface, or one side surface of the second component is formed into a striking surface, and the first component is a balance weight. Subsequently, a layer of active metal suitable for jointing with an active metal solder is coated on the first component and the second component (Step S30). The surfaces of the first component 10 and the second component are coated with a layer of active metal suitable for jointing with the active metal solder. In this preferred embodiment, the thickness of the active metal coated on the surfaces of the first component 10 and the second component is 0.1 μm to 10 μm, and the active metal is nickel, silver, or copper. Finally, the first component is joined with the second component (Step S40). After the first component 10 and the second component have been assembled, the active metal solder is added for jointing the first component 10 with the second component. Then, the two components are placed into a continuous furnace or a gas furnace, and the nitrogen gas is introduced to the heated first component 10 and second component, such that the solder is melted on the joint surface of the first component 10 and the second component. Thus, the first component 10 and the second component are jointed to form a golf club head 1.

The present invention discloses a method for jointing a golf club head, which uses a brazing joint process to perform the jointing operation. According to one preferred embodiment of the method for jointing the golf club head S1, a layer of active metal suitable for jointing with an active metal solder is coated on the first component and the second component (Step S30), wherein the surface coating method of the first component and the second component includes a physical vapor deposition, a chemical vapor deposition, an electroplating, an electroless plating, or a thermal spray coating process. Furthermore, the active metal solder is a titanium-free solder, or a nickel-based solder, a silver-based solder, or a copper-based solder; and the active metal solder is a solid soldering lug, soldering bar, or a semi-liquid soldering paste.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for jointing a golf club head, using a brazing joint process to perform the jointing operation, comprising:
providing a first component which is made of a titanium material and has a joint surface;
providing a second component which is made of a metal material and has a joint surface;
coating a layer of active metal suitable for jointing with an active metal solder on the first component and the second component, wherein a surface of the first component and a surface of the second component are respectively covered by the layer of active metal suitable for jointing with the active metal solder; and
jointing the first component with the second component, wherein the first component and the second are assembled, and the active metal solder is added for jointing the first component with the second component; the first component and the second component are placed in a continuous furnace or a gas furnace; a nitrogen gas is introduced into the continuous furnace or the gas furnace; by introducing the nitrogen gas to the heated first and second components, the solder are melted on the joint surface between the first component and the second component, such that the first component and the second component are jointed together.

2. The method for jointing a golf club head as claimed in claim 1, wherein the first component is a body and the second component is a striking plate or a head cover.

3. The method for jointing a golf club head as claimed in claim 1, wherein the first component is a striking plate or a head cover, and the second component is a body.

4. The method for jointing a golf club head as claimed in claim 2, wherein the striking plate has a cup-shaped cross section.

5. The method for jointing a golf club head as claimed in claim 3, wherein the striking plate has a cup-shaped cross section.

6. The method for jointing a golf club head as claimed in claim 1, wherein the first component does not include a striking surface, or one side surface of the first component is formed into a striking surface, and the second component is a balance weight.

7. The method for jointing a golf club head as claimed in claim 1, wherein the second component does not include a striking surface, or one side surface of the second component is formed into a striking surface, and the first component is a balance weight.

8. The method for jointing a golf club head as claimed in claim 1, wherein the active metal is nickel, silver, or copper.

9. The method for jointing a golf club head as claimed in claim 1, wherein the active metal solder is further a titanium-free solder.

10. The method for jointing a golf club head as claimed in claim 1, wherein the active metal solder is a nickel-based solder, a silver-based solder, or a copper-based solder.

11. The method for jointing a golf club head as claimed in claim 1, wherein in the step of coating a layer of active metal suitable for jointing with an active metal solder on the first component and the second component, a thickness of the active metal coated on the surface of the first and second components is 0.1 μm to 10 μm.

12. The method for jointing a golf club head as claimed in claim 1, wherein in the step of coating a layer of active metal suitable for jointing with an active metal solder on the first component and the second component, the surface coating method for the first component and the second component includes a physical vapor deposition, a chemical vapor deposition, an electroplating, an electroless plating, or a thermal spray coating process.

13. The method for jointing a golf club head as claimed in claim 1, wherein the active metal solder is a solid soldering lug, soldering bar, or a semi-liquid soldering paste.
